(19) United States
(12) Patent Application Publication
(10) Pub. No.: US 2009/0100646 A1
(43) Pub. Date: Apr. 23, 2009

(54) Binding Belt

(76) Inventor: Bei Wang, Dongguan (CN)

Correspondence Address: GLOBAL IP SERVICES, 7285 W. Eagle Court, Winton, CA, 95388, US

(21) Appl. No.: 11/873,949

(22) Filed: Oct. 17, 2007

(51) Int. Cl. F16B 45/00

(52) U.S. Cl. 24/265 H

(57) ABSTRACT

This invention makes an improved binding belt known to all including two drag hook and the elastic belt that links them, in which there are holes at the end of drag hook's main section for the fingers going through it. Through this hole, the user can easily exert force to the drag hook without slip-off. Also, the drag hook and the elastic belt are molded through the single injection mould. After adopting the above technique, with the containing hole at the end of drag hook's main section, the users can grip their fingers in the hole and pull the elastic belt, which can enable the user to apply the force better and also avoid the slip-off of the drag hook, making it very convenient to use. Since drag hooks and the elastic belt are molded through the single injection mould-, the connection between the drag hook and elastic belt is firmer so as to avoid the slip-off.

### FILED OF THE INVENTION

This invention is about a type of binding belt, especially one that consists of an elastic belt and drag hooks to fix the objects.

### BACKGROUND OF THE INVENTION

Binding belt is extensively used in the daily life, one of which is composed of an elastic belt and the drag hooks on the two ends. Being used, the drag hooks on the two ends stretch the elastic belt and the belt then wraps the object. Then, hook the drag hook's front hanger to some fixed object. In this way, the elastic belt binds the object tightly under its elastic restoring force and thus fixes the object.

The binding belts available in the market now have no holes for the finger crossing in the main section of the drag hooks. The users can only grab the hook with their fingers and pull the elastic belt. However, in this way the hook can become deformed and even break easily. If the force is applied by the hands grabbing the main section of the drag hook, it is so slippery that fingers can be loose off easily and it is hard to pull the drag hook to the right place. In addition, for the existing binding belts, the drag hooks and elastic belt are not molded through the single mould. Being used, the elastic belt can easily become loose off from the end of drag hooks if the pulling force is huge, which can cause a lot of trouble to the users.

### SUMMARY OF THE INVENTION

This invention is an improved binding belt aiming to improve the existing binding belts. Its merits lie in that it is easy to use and the drag hooks and elastic belt connects firmly.

To achieve the above purpose, this improved binding belt composes of two drag hooks and the elastic belt that connects them. The feature is that there are holes for finger crossing at the body of drag hooks' main sections, through which the users can apply force on the hooks without being slippery and loosing off.

A non-slip means is set on the side of drag hook's end section as improvement to the above technical plan.

The above drag hook and elastic belt are molded in the single injection mould as improvement to the above technical plan.

In the mentioned drag hook's main section there are embedded metal frame, whose end is tied together with the core wire in the elastic belt as improvement to the above technical plan.

After adopting the above technique, this invention's efficiency comes from: with the hole at the end of drag hook's main section, the users can grip their fingers in the hole and pull the elastic belt, which can enable the user to apply the force better and also avoid the slip-off of the drag hook, making it very convenient to use. Since drag hooks and the elastic belt are molded through the single injection mould-, the connection between the drag hook and elastic belt is firmer so as to avoid the slip-off.

### BRIEF DESCRIPTION OF THE DRAWINGS

Together with the attached pictures, the following further illustration on this invention is given.

FIG. 1: schematic picture of the overall structure in this invention

FIG. 2: schematic picture of the overall structure in this invention from another angle

FIG. 3: section view of linking between the elastic belt and drag hook in this invention

### DETAILED DESCRIPTION OF THE INVENTION

The following is a better example of executing this invention, which is not restricted to the protective scope of this invention.

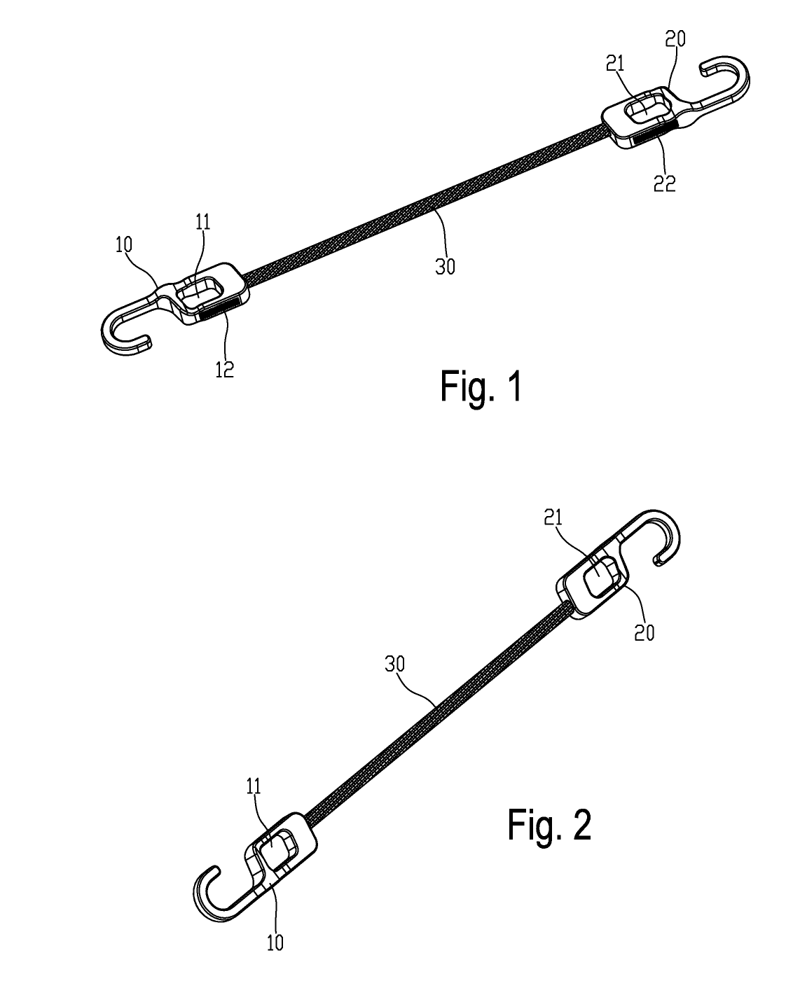

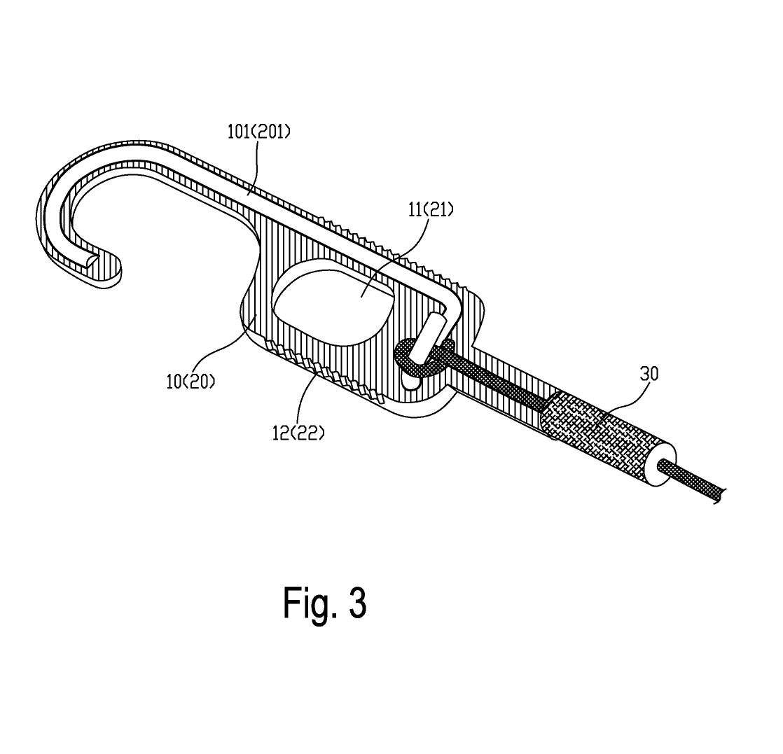

As shown in Attached FIG. 1 to FIG. 3, the binding belt in this invention includes two drag hooks 10, 20 and the Elastic Belt 30 linking Drag Hook 10 and Drag Hook 20. At the end of Drag Hook 10 and Drag Hook 20, there are Hole 11 and Hole 21 where the fingers can go through. Through these holes 11 and 21, the users can grip the fingers in the holes and exert force to the drag hook. It is convenient and the drag hook will not slip from the fingers. When the user is pulling Drag Hook 10 and 20, the surface of the thumb is pressed on the side of Drag Hook 10 and 20's main section. Non-Slip Means 12 and 22 are set on the side of Drag Hook 10 and 20's main section to strengthen the adhesive force between the fingers and Drag Hook 10 and 20.

Drag Hook 10, Drag Hook 20 and Elastic Belt 30 are molded through the single injection mould. The details are: first, tie the end of Core Wire 301 of Elastic Belt 30 to the ends of metal frame 101 and 201 embedded in Drag Hook 10 and 20. Later, put metal frame 101 and 201 into the mould for injection and the outside forms a plastic cover. In this way, Elastic Belt 30 and Drag Hook 10 and 20 are connected together, which can stand great force and will not become loose off.

What is claimed is:

1. An improved binding belt comprising:
two drag hooks;
an elastic belt, its two ends connecting said two drag hooks;
said drag hook including a body with a hood, said body having a finger crossing hole for expediently drawing the elastic belt by finger when binding.

2. The binding belt of claim 1 wherein a non-slip means is set on the side of the body of said drag hook for finger holding said drag hook tightly.

3. The binding belt of claim 1, wherein said drag hook is made by plastic mold and the end of said elastic belt is molded in said drag hook.

4. The binding belt of claim 2, wherein said drag hook is made by plastic mold and the end of said elastic belt is molded in said drag hook.

5. The binding belt of claim 3, wherein the drag hook made by plastic has an embedded metal frame with a shape corresponding to the drag hook, said elastic belt is tied with the metal frame, the metal frame and tied end of the elastic belt are enwrapped by plastic.

6. The binding belt of claim 4, wherein the drag hook made by plastic has an embedded metal frame with a shape corresponding to the drag hook, said elastic belt is tied with the metal frame, the metal frame and tied end of the elastic belt are enwrapped by plastic.
